(19) United States
(12) Patent Application Publication
(10) Pub. No.: US 2020/0017242 A1
(43) Pub. Date: Jan. 16, 2020

(54) Orbital radiation shield enclosure

(71) Applicant: Jonathan Armstead, Washington, DC (US)

(72) Inventor: Jonathan Armstead, Washington, DC (US)

(21) Appl. No.: 15/998,201

(22) Filed: Jul. 16, 2018

(51) Int. Cl. B64G 1/54; B64G 1/10; B64G 1/28; B64G 1/24

(52) U.S. Cl. CPC B64G 1/543; B64G 1/10; B64G 1/002; B64G 1/24; B64G 2700/24; B64G 1/28

(57) ABSTRACT

This new and useful invention provides personnel and equipment protection from radiation threats in space. It supplements or replaces current board radiation shielding of spacecraft. and is a scalable individual space borne enclosure (or system of enclosures) large enough to enclose various manned spacecraft types. This enclosure, which is comprised of proven radiation shielding material like hydrogen rich polyethylene, is deployable from the Earth's surface into an elliptical orbit around the Earth or other planetary bodies with a perigee in LEO and its apogee substantially above the Earth's Van Allen Radiation Belts.

The inventions functionality is that spacecraft which must traverse the Earth's Van Allen Radiation Belts may match orbits with and dock inside the enclosure during such transits. After passing through the zones of highest radiation the spacecraft may emerge from the protective orbital shield and commence any further maneuvers. The enclosure deploys on orbit after launch from the Earth using centrifugal force.

This new and useful invention is of utility in the region of space beyond most of the Earth's atmosphere. This region begins at approximately 62 miles above Earth's sea level and includes what is generally known as near Earth orbit and outer space. This invention functions as a radiation shield for men, equipment and goods as they traverse zones of high radiation in space. This radiation includes solar radiation, radiation incident to the Earth's Van Allen Belts and cosmic radiation which includes high energy particle radiation.

Prior to this invention, traversing near earth space and further manned exploration beyond Earth has proven prohibitively difficult due the doses of radiation to which crew, equipment and goods may be subjected in space. Physical radiation shielding techniques and orbital paths intended to minimize exposure time are in current use to address this issue. However, physical shielding on board a spacecraft requires additional fuel on board to propel it. Additionally, orbital trajectories which limit time of exposure do not fully address the repeated radiation exposure which routine travel in space imposes. This invention's utility is that it reduces the amount of radiation shielding, (either of the passive physical barrier type or of an active electromagnetic type), which a spacecraft must carry to be safe from radiation in space. Its functionality and design are as follows

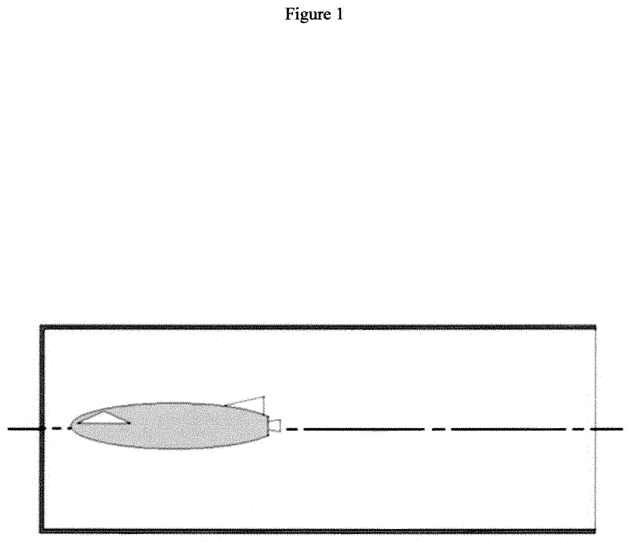

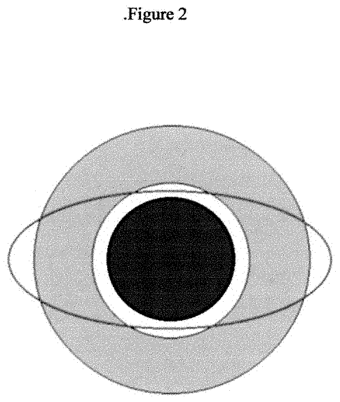

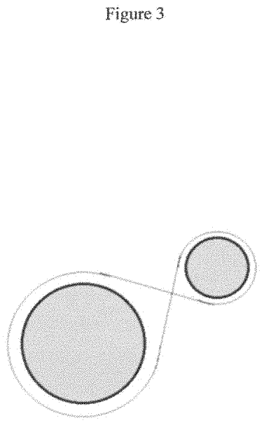

This new invention is a large radiation shield enclosure intended to be deployed along regular predetermined orbital paths. Spacecraft launched from Earth or returning to Earth from interplanetary space use the shield by matching the enclosure's orbital path and then maneuvering fully into it. While inside the enclosure, the spacecraft is protected from radiation threats to its occupants. (FIG. 1) Upon reaching its destination, the spacecraft may exit the enclosure and proceed to its next maneuver. An orbital path along which a shielding technique of this type would be very useful is one in which the perigee is in low Earth orbit and the apogee is above the Earth's Van Allen Belts. (FIG. 2) Other shield enclosures of this utility may be placed in “cycler “orbits” between regularly traversed planetary bodies and moons as needed. (FIG. 3) Spacecraft regularly traversing either the Earth's Van Allen Radiation Belts or interplanetary space may regularly match orbits with and use the shield devices of the type described here for protection as they travel. Multiple examples of these orbital shield structures could be placed in Trans Van Allen Belt orbits and along regular “cycle?” orbits between the Earth and Moon or Earth and Mars. This space borne transportation system would facilitate a more efficient, cost effective and rapid commercialization of solar space.

The design of this invention facilitates both ease of manufacture on the Earth's surface and ease of operational deployment in space. The primary structure is essentially of unitary construction and has no moving parts. Once fabricated, it can be folded up and placed within the cargo bay of a launch vehicle similar to a Space X Falcon heavy or a Delta Heavy. The invention is then boosted by the launch vehicle into the useful elliptical or “cycle?” orbit selected for it and then self-deployed without further manual construction activity. The invention structure is essentially a huge capped cylinder capable of fully enclosing a spacecraft and comprised of many closely spaced layers of high density polyethylene plastic. Each layer, for the purpose of this description, is a cylindrical tube whose wall is 3 mil in thickness. The end cap or base of the tube is capped by a circular polyethylene sheet of similar thickness and density which is heat bonded at its edge to the cylindrical portion of the “bag”. This 3 mil gauge of high density polyethylene is in general worldwide manufacture and is used in many products like plastic tarps and plastic contractor bags. In this utility, the space radiation shield structure is comprised of as many layers of polyethylene cylinders as required to achieve sufficient protection from space radiation for any craft sharing its orbital path and parked inside it. Protecting this multi layered polyethylene structure from thermal radiation is an outer sheath comprised of reflectively coated polyethylene sheet. This outer sheath is accompanied, in this invention, by an inner sheath of the same reflective material. Both the inner and outer reflective sheaths of this invention are constructed in the same manner as the non-reflective layers of the enclosure. In brief, the core, non-reflective, layers of this shield structure serve as a physical ballistic barrier to highly charge particles in space. The outer and inner reflective layers of the orbital shield protect the core structure from thermal damage. The structure (which self deploys by means of a slow rotation around its cylindrical central axis imparted to it) will have in operation the appearance of a huge gold colored slowly rotating drum with a spacecraft floating deep inside. Entry to and egress from the shield structure is by means of one of its circular ends being open to space. Shielding of any craft parked inside during transit is not compromised by one end of the tube being open to space. This is because any craft pulling into the protective structure nose first will have its business end (metal drive structure, fuel, cargo, etc.) placed between the radiation outside of the tube and the humans housed at the closed end. Shielding from the rear is provided by the mass of the spacecraft itself (FIG. 1)

This page of the invention specification is pursuant to 37 CFR 1.74 and 1.77(b)(9) and includes brief descriptions of the following drawings: Page Seven FIG. 1. depicts a cross section of the orbital shield with a spacecraft inside as it would be in nominal deployed use. Page Eight FIG. 2. depicts an orbital path (represented by the ellipse) of the type which is essential to the invention's radiation shielding function. The point at which the ellipse is closest to the central darkened circle (the Earth) represents the perigee of that orbital path. That orbital perigee is essentially below the zone of dangerous radiation which is represented here by the grayed zone surrounding the Earth. The point at which the ellipse is furthest from the Earth is the orbital apogee and is essentially above the zone of dangerous radiation from which the shield device provides protection to its occupants. Page Nine FIG. 3. depicts an orbital path represented by the figure eight surrounding two circles (the Earth and Moon or any other two planetary bodies). His type of orbital path is called a “cycler” orbit and is useful in that a shield enclosure as described in this specification can be entered near one orbital body and exited near another. This method allows shielding for its occupants during the transit period between the to orbital bodies.

I make the following claims for this new and useful Orbital Radiation Shield Enclosure invention:

1. A radiation shielding enclosure into which a spacecraft may maneuver which travels in an orbit which at its perigee is substantially below the Van Allen Radiation Belts and at its Apogee is substantially above the Van Allen Radiation Belts.

2. A radiation shielding enclosure into which a spacecraft may maneuver which travels in a “cycler” orbit between two or more planetary bodies.

3. A radiation shielding enclosure, as above, which may be launched from the earth substantially in one piece and in a folded state. This allows it to fit into a launch vehicle.

4. A radiation shielding enclosure, as above, which upon reaching its deployed station unfolds into its useful form by means of centrifugal force. This centrifugal force may be induced by rotation which is imparted to it by the launch vehicle, compressed gas or pyrotechnic means.

5. A radiation shielding enclosure, as above, which is constructed of layers of plastic material, such as hydrogen containing Polyethylene.
